(19) United States
(12) Patent Application Publication
(10) Pub. No.: US 2013/0280499 A1
(43) Pub. Date: Oct. 24, 2013

(54) FOUNTAIN SOLUTION AND FOUNTAIN SOLUTION CONCENTRATES

(71) Applicants: Hiroyasu Kanno, Tokyo (JP); Yoshihisa Fujii, Tokyo (JP); Motoyuki Setoguchi, Tokyo (JP); Masahiko Shinnishi, Saitama (JP)

(72) Inventors: Hiroyasu Kanno, Tokyo (JP); Yoshihisa Fujii, Tokyo (JP); Motoyuki Setoguchi, Tokyo (JP); Masahiko Shinnishi, Saitama (JP)

(73) Assignee: BASF SE, Ludwigshafen (DE)

(21) Appl. No.: 13/882,360

(22) PCT Filed: Oct. 25, 2011
(86) PCT No.: PCT/EP2011/068664

§ 371 Date: Jul. 3, 2013

(30) Foreign Application Priority Data
Oct. 28, 2010 (JP) 10/242557

(51) Int. Cl. C09D 5/00

(52) U.S. Cl. CPC C09D 5/00
USPC 428/195.1; 106/287.26; 101/492

(57) ABSTRACT

The present invention relates to a fountain solution concentrate for offset printing comprising tert.-amyl alcohol. The present invention also refers to a fountain solution obtained by the addition of water to the fountain solution concentrate. Another aspect of the present invention is a method for offset printing wherein a fountain solution according to the present invention is applied to the image plate to desensitize the non-image areas of the image plate and the printed media obtainable thereby.

The present invention relates to fountain solutions and a fountain solution concentrate for use in offset printing and methods for their manufacture. The present invention also refers to the use of tert.-amyl alcohol in fountain solutions or fountain solutions concentrates for offset printing. In addition the present invention refers to a method for offset printing wherein a fountain solution according to the present invention is applied to the image plate to desensitize the non-image areas of the image plate as well as to printed media obtained with this method.

Offset printing is a commonly used printing technique where the inked image is transferred (or “offset”) from a lithographic plate to a rubber blanket, then to the printing surface.

In offset printing, the lithographic plate is designed in such as fashion that the positive image areas have a hydrophilic surface while the negative image areas have a hydrophobic surface.

The lithographic plate is generally treated with a so called fountain solution. The fountain solution is usually a hydrophilic water based composition which adheres to the hydrophilic non-image areas of the lithographic plate. The treatment of the lithographic plate with a fountain solution insures that the hydrophobic ink solutions which are applied in the next processing step only adhere to the hydrophobic imaging areas of the plate. The function of the fountain solution is therefore to desensitize the non-image areas rendering them ink-repellent.

Commonly known fountain solutions comprise water, alkali metal salt or ammonium salt of dichromic acid, phosphorous acid or salts of phosphorous acid and a colloidal substance, such as gum arabic or carboxymethyl cellulose (CMC).

Solutions based on these substances alone have the disadvantage that they do not wet the non-image areas of the printing plate sufficiently.

If too little fountain solution is applied, the nonprinting areas will not accept enough moisture and will accept some ink, which subsequently will be transferred to the paper. On the other hand, if too much fountain solution is applied to the plate, it will dilute the ink and cause the printed image to have a washed-out appearance.

If the fountain solution is applied unevenly, so that too little fluid is applied to some portions of the plate and too much is applied to other portions of the plate, the final printed image will have some undesired areas inked and other areas wherein the image is washed out.

Therefore a considerable amount of skill and experience is required in controlling the feed rate of such fountain solutions to the printing plate.

To overcome this problem, a wetting agent is normally added to the fountain solution. A wetting agent reduces the surface tension of the fountain solution allowing the rapid formation of a thin, even film of the fountain solution on the non-image areas.

Dahlgren (U.S. Pat. No. 3,705,451) has suggested the use of isopropyl alcohol as a wetting agent and fountain solutions known as “Dahlgren systems” have become standard in the industry.

The use of isopropyl alcohol in fountain solutions has many advantages in addition to reducing surface tension. It also increases the viscosity of the solution allowing a thicker film to be applied to the rollers and/or the plate. The high volatility of isopropyl alcohol means that it will evaporate more quickly before being transferred to the blanket minimizing wash out effects and ink-bleeding. Its tendency to emulsify the ink to a lesser extent than other liquids reduces snowflaking (small, white, unprinted specks in printed solids and type). In addition, isopropyl alcohol tends to allow greater print quality right at startup, which is a cost-effective benefit.

However, Environmental Protection Agency (EPA) and Occupational Safety and Health Administration (OSHA) regulations (such as those calling for the reduction of volatile organic compounds) are limiting the use of isopropyl alcohol in fountain solutions. For instance, measures must be taken when concentrations of 5% by weight or greater are used, such as installation of ventilation, measurements of the working environment and health checks of workers.

Several of the disadvantages of isopropyl alcohol—such as its expense, toxicity, flammability, and need for adequate ventilation in areas of its use—are causing substitutes to be more frequently utilized.

These substitutes include polyhydric alcohols, glycol, glycol ethers and derivatives thereof frequently in combination with ethylene glycol (e.g. U.S. Pat. No. 3,877,372 or U.S. Pat. No. 5,695,550). These substitutes can either completely replace isopropanol or they can be added as a supplement to it, reducing the total isopropanol concentration.

US 2009/0081592 mentions fountain solution compositions comprising at least one acyclic hydrocarbon diol compound, having 6 to 8 carbon atoms in total and two hydroxyl groups at the 1- and 2-positions, respectively.

U.S. Pat. No. 4,278,467 discloses a fountain solution containing at least one member selected from the group consisting of n-hexoxyethylene glycol, n-hexoxydiethylene glycol, 2-ethyl-1,3-hexanediol, n-butoxyethylene glycol acetate, n-butoxydiethylene glycol acetate and 3-butoxy-2-propanol.

Fountain solutions comprising 2-ethyl-1,3-hexanediol and at least one member selected from the group consisting of propylene glycol, ethylene glycol, dipropylene glycol, diethylene glycol, hexylene glycol, triethylene glycol, tetraethylene glycol, tripropane glycol and 1,5-pentanediol are mentioned in U.S. Pat. No. 4,560,410.

As these fountain solutions do not contain isopropyl alcohol, they are preferable in view of safety and hygiene. However, the wettablility with respect to non-image areas of a lithographic printing plate during printing operation is not sufficient and it is sometimes observed that the non-image areas are contaminated, in particular, during high speed printing operation. This may cause so-called ink spreading of half dot image portions, a phenomenon wherein the shape of half dot images is abnormally deformed. Moreover, 2-ethyl-1,3-hexanediol is not sufficient soluble in water and thus the use thereof is unfavorable to obtain a fountain solution concentrate or an additive for a fountain solution having a high concentration.

U.S. Pat. No. 5,106,414 discloses fountain solutions consisting of aliphatic alcohols or diols having 5 to 11 carbon atoms to which 1 to 10 units of ethylene oxide are added. A similar fountain solution is mentioned in U.S. Pat. No. 5,308,388 in which alkanols, alkenols or alkanediols or alkenediols having 5 to 15 carbon atoms are converted with 3 to 12 ethylene oxide and or propylene oxide units. Such substitutes are added to the fountain solutions in low amounts which have little effect on the viscosity of the fountain solution. Therefore higher roller speeds in continuous-flow dampening systems are required when using such solutions.

The object of the present invention was to provide a fountain solution which allows for an excellent print reproducibility, e.g. an exact transfer of the image to the printed medium. Therefore it was an object of the present invention to provide a fountain solution which minimizes bleeding. It was also an object of the present invention to provide a fountain solution which allows a smooth operation in offset printing, e.g. a minimizing of ink piling on the blanket. Another aim of the present invention was to provide a fountain solution with enables proper emulsification of the ink, e.g. to prevent over-emulsification, which may result in unclear images or images having voids or to prevent insufficient water uptake (poor emulsification), which in turn may result in poor ink transfer and ink piling on the blanket. It was also intended to enable a higher throughput during printing operations. Therefore it was the aim to provide a fountain solution having a low dynamic surface tension in order to enhance the desensitizing properties and a sufficiently high dynamic viscosity to allow an even distribution of fountain solution on the image plate. In addition it was intended to provide a fountain solution having a wetting agent showing a reasonable tendency to evaporate in order to minimize wash out effects and ink-bleeding. A still further object of the present invention is to provide a fountain solution or a fountain solution concentrate which is not subject to current health and environmental regulations.

The object of the present invention is solved by a fountain solution for offset printing comprising water and tert.-amyl alcohol (2-methyl-2-butanol).

The present invention also relates to a fountain solution concentrate for offset printing which can be diluted with water to provide a ready-to-use fountain solution according to the present invention. The advantage of providing a fountain solution concentrate is that water must not be transported from the manufacturer of the concentrate to the operator of the printing machine.

The fountain solution concentrate of the present invention comprises tert.-amyl alcohol (2-methyl-2-butanol).

The fountain solution concentrate comprises 10 to 100% by weight of tert.-amyl alcohol, preferably 20 to 95% by weight, more preferably 5 to 75% by weight, even more preferably between 7.5 to 60% by weight and most preferably 10 to 50% by weight.

Besides tert.-amyl alcohol, the fountain solution concentrate may also comprise auxiliary wetting agents.

Preferably the auxiliary wetting agents are surfactants or auxiliary wetting solvents, which are miscible with tert.-amyl alcohol.

Surfactants are preferably nonionic, anionic surfactants, N-alkylpyrrolidones and acetylene alcohols and their derivatives.

Preferable anionic surfactants are fatty acid salts, abietate, hydroxyalkanesulfonate, alkanesulfonate, dialkyl sulfosuccinate, linear alkylbenzene sulfonate, branched alkylbenzene sulfonate, alkylnaphthalenesulfonate, alkylphenoxy polyoxyethylene propylsulfonate, polyoxyethylene alkylsulfenyl ether salt, N-methyl-N-oleyl taurine sodium salt, N-alkyl sulfosuccinic acid monoamide disodium salt, petroleum sulfonate, sulfated castor oil, sulfated beef tallow oil, sulfuric ester salt of fatty acid alkyl ester, alkyl sulfuric acid ester salt, polyoxyethylene alkyl ether sulfuric ester salt, fatty acid monoglyceride sulfuric ester salt, polyoxyethylene alkylphenyl ether sulfuric ester salt, polyoxyethylene styrylphenyl ether sulfuric ester salt, alkyl phosphoric ester salt, polyoxyethylene alkyl ether phosphoric ester salt, polyoxyethylene alkylphenyl ether phosphoric ester salt, partially saponified product of styrene-maleic anhydride copolymer, partially saponified product of olefin-maleic anhydride copolymer, naphthalene sulfonate formalin condensate and the like.

Preferable nonionic surfactants are polyoxyethylene alkyl ether, polyoxyethylene alkylphenyl ether, polyoxyethylene polystyrylphenyl ether, polyoxyethylene polyoxypropylene alkyl ether, glycerol fatty acid partial ester, sorbitan fatty acid partial ester, pentaerythritol fatty acid partial ester, propylene glycol mono fatty acid ester, sucrose fatty acid partial ester, polyoxyethylene sorbitan fatty acid partial ester, polyoxyethylene sorbitol fatty acid partial ester, polyethylene glycol fatty acid ester, polyglycerin fatty acid partial ester, polyoxyethylenated castor oil, polyoxyethylene glycerol fatty acid partial ester, fatty acid diethanol amide, N,N-bis-2-hydroxy alkylamine, polyoxyethylene alkylamine, triethanolamine fatty acid ester, trialkylamine oxide and the like. In addition, fluorochemical surfactants and silicon surfactants may be used.

Preferable N-alkylpyrrolidones are N-ethyl pyrrolidone, N-butyl pyrrolidone, N-pentylpyrrolidone, N-hexylpyrrolidone, N-octylpyrrolidone and N-laurylpyrrolidone. Preferable acetylene alcohols and their derivatives are 3,5-dimethyl-1-hexyne-3-ol, 2,5-dimethyl-3-hexyne-2,5-diol, 2,4,7,9-tetramethyl-5-decyne-4,7-diol, 3,6-dimethyl-4-octyne-3,6-diol, 2-butyne-1,4-diol, 3-methyl-1-butyne-3-ol, adduct compounds of ethylene oxide and/or propylene oxide to the above acytelene alcohols, such as ethoxylated 2,4,7,9-Tetramethyl-5-decyn-4,7-diol (available as Surfynol® 440), and the like. Among these, 3,6-dimethyl-4-octyne-3,6-diol, 2,4,7,9-tetramethyl-5-decyne-4,7-diol, and an adduct compound of 4 to 10 ethylene oxides to 2,4,7,9-tetramethyl-5-decyne-4,7-diol are preferable.

In addition, combination of two or more surfactants can be employed.

The amount of surfactants based on the total weight of the fountain solution concentrate is generally between 0 to 15% by weight, preferably 1 to 10% by weight and more preferably 3 to 8% by weight.

The auxiliary wetting solvent is a solvent which fully or at least partly miscible with tert.-amyl alcohol.

Preferably, the auxiliary wetting solvent being miscible with tert.-amyl alcohol are alcohols, ethers of polyhydric alcohols, such as adducts of polyhydric alcohols with ethylene or propylene oxide.

More preferably auxiliary wetting solvent having a miscibility with tert.-amyl alcohol are selected from the group consisting of n-propyl alcohol, n-pentyl alcohol, 2-methyl-1-butanol, 2,2-dimethyl-1-propanol, 2,2-dimethyl-2-propanol, 1-pentanol, 2-pentanol, 3-pentanol, 2-methyl-1-butanol, 3-methyl-1-butanol, 2-methyl-2-butanol, 3-methyl-2-butanol, 1-octanol, 2-octanol, 2-ethylhexanol, ethylene glycol, ethylene glycol monoisopropyl ether, ethylene glycol mono-n-propyl ether, ethylene glycol mono-n-butyl ether, ethylene glycol mono-tertiary-butyl ether, diethylene glycol, diethylene glycol mono-n-butyl ether, diethylene glycol monoethyl ether, propylene glycol, propylene glycol monomethyl ether, propylene glycol monoethyl ether, propylene glycol mono-n-propyl ether, propylene glycol mono-n-butyl ether, propylene glycol monoisobutyl ether, dipropylene glycol, dipropylene glycol monomethyl ether, dipropylene glycol monoethyl ether, dipropylene glycol monobutyl ether, dipropylene glycol isobutyl ether, triethylene glycol, triethylene glycol monomethyl ether, triethylene glycol monoethyl ether, triethylene glycol monobutyl ether, butylene glycol, glycerine, 3-methoxy-3-methylbutane.

The amount of auxilliary wetting solvent having a miscibility with tert.-amyl alcohol based on the total weight of the fountain solution concentrate is generally between 0 to 60% by weight, preferably 5 to 55% by weight more preferably 10 to 50% by weight and most preferably 15 to 50% by weight.

In a preferred embodiment, the fountain solution concentrate comprises less than 10% by weight, preferably less than 5% by weight and most preferably less than 1% by weight of isopropyl alcohol. Most preferably the fountain solutions and fountain solutions concentrates according to the present invention do not comprise isopropyl alcohol.

In a further preferred embodiment of the present invention, the fountain solution concentrate according to the present invention also comprises water.

The amount of water based on the total weight of the fountain solution concentrate is generally between 0 to 75% by weight, preferably 5 to 75% by weight, more preferably 7.5 to 60% by weight and most preferably 15 to 55% by weight

The fountain solution according to the present invention may optionally also comprise desensitizing agents, pH-adjusting agents, chelating agents and other additives, such as odor masking agents, preservatives, anti-corrosives, anti-foaming agents etc.

The amount and choice of additional components depends on the application area and printing set and is known to a person skilled in the art.

The fountain solution concentrate may optionally comprise a desensitizing agent to impart to non-image areas water-receptivity and ink-repellency.

Examples of the aqueous desensitizing agent include aqueous solutions of water soluble natural polymers such as gum arabic, dextrin and carboxymethyl cellulose, and aqueous solutions of water soluble synthetic polymers such as polyvinyl alcohol, polyvinyl pyrrolidone and polyacrylic acid.

The amount of desensitizing agent in the fountain solution concentrate is preferably in the range of 0 to 15% by weight, more preferably 1 to 10% by weight and most preferably 3 to 8% by weight based on the weight of the fountain solution concentrate.

The fountain solution concentrate may additionally comprise a pH-adjusting agent. pH adjusting agents may be used to adjust a specific pH-range in the fountain solution or to buffer the fountain solution.

Fountain solutions are preferably slightly to moderately acidic, e.g. in the pH-range of 3 to 7, if desensitizing agents such as gum arabic is used because gum arabic may lose its effectiveness if the pH rises above 5. In this case, it may lose its ability to adhere to the plate, and ink may begin to adhere to the plate in the non-image areas, a problem known as scumming. However, excessive acidity can also cause scumming (as the acid eats away the protective plate coating), as well as plate blinding, in which the acid eats away the image areas of the plate, causing a lack of ink receptivity. Increased acidity can also cause roller stripping, or the lack of ink receptivity of the ink rollers. Fountain solutions are preferably slightly alkaline, e.g. in the pH-range of 7 to 11, if alkaline paper or paper containing calcium carbonate either as a filler or a coating is used in the printing process. Calcium carbonate is an alkaline material, and when particles of it come into contact with an acidic fountain solution, deleterious effects can occur. If slightly alkaline fountain solutions are desired, it is additionally preferred not to use gum as a desensitizing agent.

pH-adjusting agents are usually water-soluble organic and/or inorganic acids and/or salts thereof.

Preferable organic acid includes, for example, citric acid, ascorbic acid, malic acid, tartaric acid, lactic acid, acetic acid, gluconic acid, acetic acid, hydroxyacetic acid, oxalic acid, malonic acid, levulinic acid, sulfanilic acid, p-toluenesulfonic acid, phytic acid, an organic phosphonic acid and the like.

Preferable inorganic acid includes phosphoric acid, nitric acid, sulfuric acid, polyphosphoric acid and the like.

In addition, alkali metal salts, alkaline earth metal salts, ammonium salts or organic amine salts of these organic and/or inorganic acids, in particularly alkali metal carbonates, alkaline earth metal carbonates, alkali metal silicates or alkaline earth metal silicates, especially sodium carbonate or sodium silicate, can be preferably used, and such organic and inorganic acids and salts thereof can be used either alone or in combination of more than one.

The amount of pH-adjusting agent based on the total weight of the fountain solution concentrate is generally between 0 to 15% by weight, preferably 1 to 10% by weight and most preferably 3 to 8% by weight.

The fountain solution concentrate may optionally also contain a chelating agent.

A chelating agent is generally used as a water softener to bind calcium ions which may adversely affect the printing process.

Examples of preferred chelating agents include ethylenediaminetetraacetic acid and potassium salts and sodium salts thereof; diethylenetriaminepentaacetic acid and potassium salts and sodium salts thereof; triethylenetetraminehexaacetic acid and potassium salts and sodium salts thereof; hydroxyethylethylenediaminetriacetic acid and potassium salts and sodium salts thereof; nitrilotriacetic acid and sodium salts thereof; organic phosphonic acids such as 1-hydroxy ethane-1,1-diphosphonic acid and potassium salts and sodium salts thereof; aminotri(methylenephosphonic acid) and potassium salts and sodium salts thereof, and phosphonoalkanetricarboxylic acids. Organic amine salts may also be used as chelating agents.

The amount of chelating agent based on the total weight of the fountain solution concentrate is generally between 0 to 5% by weight, preferably 0.1 to 2.5% by weight and most preferably 0.3 to 1% by weight of a chelating agent.

In addition, the fountain solution concentrate may also comprise other additives, such as odor masking agents, preservatives, ant-corrosives, anti-foaming agents, surface active agents etc.

Odor masking agents include esters which are conventionally known to be used as flavors. Specific examples of odor masking agents which may be used include esters of formic acid, acetic acid, propionic acid, butyric acid, isobutyric acid, 2-ethylbutyric acid, valeric acid, isovaleric acid, 2-methylvaleric acid, hexanoic acid (caproic acid), 4-methylpentanoic acid (isohexane acid), 2-hexenoic acid, 4-pentene acid, heptanoic acid, 2-methylheptane acid, octanoic acid (caprylic acid), nonanoic acid, decanoic acid (capric acid), 2-decenoic acid, lauric acid or myristic acid. In addition, odor masking agents also includes acetoacetic esters such as benzyl phenylacetate, ethyl acetoacetate and 2-hexyl acetoacetate. Among these, n-pentyl acetate, isopentyl acetate, n-butyl butyrate, n-pentyl butyrate and isopentyl butyrate are preferred and, in particular, n-butyl butyrate, n-pentyl butyrate and isopentyl butyrate are preferred.

Preservatives which may be used for the fountain solution concentrate of the present invention include phenol or derivatives thereof, formalin, imidazole derivatives, sodium dehydroacetate, 4-isothiazolin-3-one derivatives, benztriazole derivatives, derivatives of amidine or guanidine, quaternary ammonium salt, pyridine, derivatives of quinoline or guanidine, derivatives of diazine or triazole, derivatives of oxazol or oxazin, bromonitro alcohols such as bromonitro propanol, 2,2-dibromo-2-nitro ethanol, 3-bromo-3-nitro pentane 2,4-diol, and the like. Preferable amount of the preservative to be added is such that stably exhibit its effect on bacteria, fungi, yeasts and the like, and varies with the types of the bacteria, fungi and yeasts.

Anticorrosives which may be used for the invention include benzotriazole, 5-methylbenzotriazol, thiosalicylic acid, benzimidazole and derivatives thereof and the like.

The amount of other additives based on the total weight of the fountain solution concentrate is generally between 0 to 15% by weight, more preferably 1 to 10% by weight and most preferably 3 to 8% by weight, based on the weight of the fountain solution concentrate.

In a preferred embodiment, the fountain solution concentrate according to the present invention comprises:

tert.-amyl alcohol: 15 to 75% by weight and/or
water: 0 to 75% by weight; and/or
auxiliary-wetting solvent: 0 to 60% by weight and/or
desensitizing agents: 0 to 15% by weight and/or
pH-adjusting agents: 0 to 15% by weight and/or
chelating agents: 0 to 5% by weight and/or
surfactants: 0 to 15% by weight and/or
other additives, including odor masking agents, preservatives, ant-corrosives, anti-foaming agents: 0 to 15% by weight,
based on the weight of the fountain solution concentrate.

In another preferred embodiment the fountain solution concentrate according to the present invention more preferably additionally comprises:

tert.-amyl alcohol: 7.5 to 60% by weight and/or
water: 5 to 75% by weight and/or
auxiliary-wetting solvent: 5 to 55% by weight and/or
desensitizing agents: 1 to 10% by weight and/or
pH-adjusting agents: 1 to 10% by weight and/or
chelating agents: 0.1 to 2.5% by weight and/or
surfactants: 1 to 10% by weight and/or
other additives, including odor masking agents, preservatives, ant-corrosives, anti-foaming agents: 1 to 10% by weight,
based on the weight of the fountain solution concentrate.

In a more preferred embodiment the fountain solution concentrate according to the present invention more preferably additionally comprises:

tert.-amyl alcohol: 10 to 50% by weight and/or
water: 7.5 to 60% by weight and/or
auxiliary-wetting solvent: 10 to 50% by weight and/or
desensitizing agents: 3 to 8% by weight and/or
pH-adjusting agents: 3 to 8% by weight and/or
chelating agents: 0.3 to 1% by weight and/or
surfactants: 3 to 8% by weight and/or
other additives, including odor masking agents, preservatives, ant-corrosives, anti-foaming agents: 3 to 8% by weight,
based on the weight of the fountain solution concentrate.

The fountain solutions concentrates according to the present invention may be obtained by mixing tert.-amyl alcohol with water and optionally other components, such as desensitizing agent, pH-adjusting agents, chelating agents or other additives, such as odor masking agents, preservatives, anti-corrosives, anti-foaming agents, etc.

The fountain solution according to the invention is obtained by adding water to the fountain solution concentrate of the present invention.

The weight ratio of tert.-amyl alcohol to water in the obtainable fountain solutions is preferably in the range of 1:200 to 20:100, more preferably in the range of 1:100 to 10:100 and most preferably 3:100 to 5:100.

In a preferred embodiment, the fountain solution according to the present invention comprises:

tert.-amyl alcohol: 0.1 to 10%, preferably 0.3 to 10% by weight, more preferably 0.5 to 3% by weight and/or
water: 50 to 99.9% by weight, preferably 70 to 99.5% by weight, more preferably 95 to 99% by weight and/or
auxiliary-wetting solvent: 0 to 5% by weight, preferably 0.05 to 3% by weight, more preferably 0.1 to 2% by weight and/or
desensitizing agents: 0 to 5% by weight, preferably 0.05 to 3% by weight, more preferably 0.1 to 2% by weight and/or
pH-adjusting agents: 0 to 5% by weight, preferably 0.05 to 3% by weight, more preferably 0.1 to 2% by weight and/or
chelating agents: 0 to 1% by weight, preferably 0.01 to 0.5% by weight, more preferably 0.05 to 0.25% by weight and/or
surfactants: 0 to 5% by weight, preferably 0.05 to 3% by weight, more preferably 0.1 to 2% by weight and/or
other additives, including odor masking agents, preservatives, ant-corrosives, anti-foaming agents: 0 to 5% by weight, preferably 0.05 to 3% by weight, more preferably 0.1 to 2% by weight based on the weight of the fountain solution concentrate.

The use of tert.-amyl alcohol in fountain solution affords fountains solutions with superior application properties.

The fountain solution according to the present invention can easily be applied to the image plates to desensitize the non-image areas of the image plate using standard equipment known to a person skilled in the art.

The fountain solution according to the present invention allows for an excellent print reproducibility, e.g. an exact transfer of the image to the printed medium. Bleeding is significantly reduced. The fountain solutions according to the present invention also enable a smooth operation in offset printing, e.g. minimizing ink piling on the blanket and enabling a proper emulsification of the ink, preventing over-emulsification, which may result in unclear images or images having voids or too little water uptake (poor emulsification), which may result in poor ink transfer and ink piling on the blanket. The present fountain solutions enable high processing speeds during printing operations. They possess a low dynamic surface tension in order to enhance the desensitizing properties and a sufficiently high dynamic viscosity to allow an even distribution of fountain solution on the image plate. In addition, the fountain solution according to the present invention minimizes wash out effects and ink-bleeding. The fountain solutions according to the present invention are compliant with current health and environmental regulations.

Printed media obtained according to a printing process according to the present invention have a high quality, even at high processing speeds.

The present invention is exemplified by following examples:

### EXAMPLES

Following fountains solutions were prepared by mixing the respective amounts of alcohol with water:

a) 1% by weight of tert.-amyl alcohol; 99% by weight of water.
b) 3% by weight of tert.-amyl alcohol; 97% by weight of water.
c) 5% by weight of tert.-amyl alcohol; 95% by weight of water.
d) 1% by weight of tert.-butyl alcohol; 99% by weight of water (comparative example).
e) 3% by weight of tert.-butyl alcohol; 97% by weight of water (comparative example).
f) 5% by weight of tert.-butyl alcohol; 95% by weight of water (comparative example).
g) 1% by weight of isopropyl alcohol; 99% by weight of water (comparative example).
h) 3% by weight of isopropyl alcohol; 97% by weight of water (comparative example).
i) 5% by weight of isopropyl alcohol; 95% by weight of water (comparative example).

The kinematic viscosity of the mixtures was determined at 20° C. The results are listed in Table 1

The static surface tension of the mixtures was determined according to the bubble pressure method with the automatic dynamic surface tensiometer BP-D by Kyowa Interface Science Co. The results are also listed in Table 1.

TABLE 1

| | | Dynamic Surface | Feed Supply |
|---|---|---|---|
| Fountain | Dynamic viscosity | Tension | Efficiency |
| solution | [cPs] | [dynes/cm] | (FSE)¹⁾ |
| a) | 1.05 | 51.3 | 23.9 |
| b) | 1.16 | 40.4 | 37.4 |
| c) | 1.22 | 34.6 | 44.4 |
| d) | 1.04 | 58.0 | 17.0 |
| e) | 1.11 | 48.3 | 29.3 |
| f) | 1.25 | 41.8 | 39.4 |
| g) | 1.04 | 59.4 | 15.7 |
| h) | 1.15 | 51.0 | 28.5 |
| i) | 1.23 | 46.5 | 35.0 |

¹⁾FSE = Dynamic Surface Tension of Water (72.8 dyne/cm) − (Dynamic Surface Tension/Dynamic Viscosity)

It is evident, that fountain solutions based on tert.-amyl alcohol and water have a lower surface tension compared to fountain solutions based on other alcohols. However, the use of tert.-amyl alcohol in fountain solutions does not lead to an undesired reduction of fountain solution viscosity. Therefore the fountain solutions according to the present invention are able to combine a low surface tension without a sacrifice in viscosity.

Also the FSE is higher for the fountain solutions of the present invention compared to fountain solutions based on other alcohols at the same concentration. The FSE is a measure for the efficiency the fountain solution can be supplied from one roll to the other during the offset printing process.

### Applications Tests:

Following fountains solutions concentrates were prepared by mixing an amount of tert.-amyl alcohol with the respective amount of a fountain solution base mixtures comprising

water: 19% by weight;
auxiliary wetting solvent: 60% by weight;
desensitizing agent: 5% by weight;
pH-adjusting agent: 5% by weight;
chelating agent: 1% by weight;
surfactants: 5% by weight;
other additives: 5% by weight, based on the total weight of the fountain solution base mixture

The respective fountain solutions were obtained by mixing the respective amount of fountains solution concentrate with the respective amount of water.

### Fountain Solution Concentrate I:

a) tert.-amyl alcohol: 33.33% by weight;
b) fountain solution base mixture: 66.67% by weight.

### Fountain Solution I:

a) fountain solution concentrate I: 3% by weight;
b) water: 97% by weight.

### Fountain Solution Concentrate II:

a) tert.-amyl alcohol: 20% by weight;
b) fountain solution base mixture: 80% by weight.

### Fountain Solution Concentrate II:

a) fountain solution concentrate II: 2.5% by weight;
b) water: 97.5% by weight.

### Fountain Solution Concentrate III:

a) tert.-amyl alcohol: 32.3% by weight;
b) fountain solution base mixture: 64.5% by weight;
c) N-octylpyrrolidone: 3.2% by weight.

### Fountain Solution III:

a) fountain solution concentrate III: 3.1% by weight;
b) water: 96.9% by weight.

### Fountain Solution Concentrate IV:

a) tert.-amyl alcohol: 50% by weight;
b) fountain solution base mixture: 50% by weight.

### Fountain Solution IV:

a) fountain solution concentrate IV: 2% by weight;
b) water: 98% by weight.

### Fountain Solution Concentrate V:

a) tert.-amyl alcohol: 47.6% by weight;
b) fountain solution base mixture: 47.6% by weight;
c) N-octylpyrrolidone: 4.8% by weight.

### Fountain Solution V:

a) fountain solution concentrate V: 2.1% by weight;
b) water: 97.9% by weight.

### Fountain Solution Concentrate VI:

a) tert.-amyl alcohol: 47.6% by weight;
b) fountain solution base mixture: 47.6% by weight;
c) Surfynol® 440 (Air Products): 4.8% by weight.

### Fountain Solution VI:

a) fountain solution concentrate VI: 2.1% by weight;
c) water: 97.9% by weight.

### Fountain Solution Concentrate VII (Comparative Example):

a) fountain solution base mixture: 2% by weight.

### Fountain Solution VII (Comparative Example):

a) fountain solution concentrate VII: 2% by weight;
b) water: 98% by weight.

### Fountain Solution Concentrate VIII (Comparative Example):

a) fountain solution base mixture: 40% by weight;
b) isopropy alcohol: 60% by weight.

### Fountain Solution VIII (Comparative Example):

a) fountain solution concentrate VIII: 2.1% by weight;
b) water: 97.9% by weight.

Printing tests were carried out on a commercial printing machine (Mitsubishi Lithopia Max BT-2 800). The printing speed was 800 rpm.

Paper of following grade was used: Aurora® paper made by Nippon Paper Co. Printing was carried out at ambient temperatures between 20 to 25° C. and a relative humidity of 40 to 50%.

Following ink was used: WD LEO-X by Toyo Ink MFG. CO., LTD.

The printing properties using the different fountain solutions were evaluated. The results are summarized in Table 2.

TABLE 2

| | Fountain Solution | | | | | | | |
|---|---|---|---|---|---|---|---|---|
| Property | I | II | III | IV | V | VI | VII | VIII |
| Minimum water source dial | 40 | 42 | 35 | 42 | 35 | 35 | 45 | 42 |
| number¹⁾ | | | | | | | | |
| Emulsifiability²⁾ | A | A | A | A | A | A | B | C |
| Bleeding property³⁾ | A | A | A | A | A | A | B | C |
| Print reproducibility⁴⁾ | A | A | A | A | A | A | C | B |
| Blanket piling resistance⁵⁾ | A | B | A | B | A | A | C | B |

¹⁾The minimum water source dial number refers to the setting of the fountain solution feed rate control of the printing machine. The Mitsubishi printing machine used for the experiments has a dial range from 0 to 100. A small value for the water source dial number corresponds to a lower feed rate of fountain solution. To obtain the value for lowest possible setting at which stains are not generated on the paper and printing operation is stable. It is evident that the equal or lower feed rates of fountain solutions could be applied to obtain better printing properties when fountain solutions of the present inventions were used.
²⁾Emusifiability of the ink was controlled after 10 000 sheets of paper were printed at the minimum water dial number. The emulsifiability was evaluated visually and as rated according to following scale: A: good; B: somewhat bad; C: very bad. Emulsification or mixing between ink and fountain solutions occurs due to shear forces during the transfer process. If the ink takes up too much water it becomes over-emulsified it leaves voids and unclear images on the substrate. If the ink does not mix with water and forms no stable emulsion the ink may mottle and the ink transfer to the image plates will be poorer so that ink piling may occur where the ink hangs back on the plate and does not transfer onto the substrate.
³⁾The bleeding properties of the ink and the fountain solutions were evaluated visually and rated according to following scale: A: good; B: somewhat bad; C: very bad. Bleeding occurs when color pigments of the ink are eluted by the fountain solution. This effect results in a discoloration of the fountain solution and an accumulation of ink in the non-image areas of the printing plates.
⁴⁾The print reproducibility is a measure for the degree of quality of reproducing the image on the printing plate to the paper. Printing reproducibility is evaluated by the comparison of the size of a halftone dot on the printing plate compared to the size of the halftone dot on the printed paper. The print reproducibility was rated according to following scale: A: good (no significant increase of the size of the halftone dot); B: somewhat bad (moderate increase of the size of the halftone dot); C: very bad (significant increase in size of the halftone dot).
⁵⁾The blanket piling resistance is a measure for the amount of ink accumulated on the surface of the blanket used to transfer the image from the image plate to the paper. The blanket piling resistance is good, if little or no ink has accumulated on the blanket and bad if a visually significant amount of ink has accumulated on the blanket. The blanket piling resistance was rated according to following scale: A: good; B: somewhat bad; C: very bad.

1. A fountain solution concentrate comprising tert.-amyl alcohol.

2. The fountain solution concentrate of claim 1 comprising 20 to 95% by weight of tert.-amyl alcohol.

3. The fountain solution concentrate of claim 1, further comprising water, wherein a weight ratio of tert.-amyl alcohol to water is in a range of 95:5 to 70:30.

4. The fountain solution concentrate of claim 1, comprising at least one selected from the group consisting of:
7.5 to 60% by weight of tert.-amyl alcohol;
5 to 75% by weight of water;
5 to 55% by weight of an auxiliary wetting solvent;
1 to 10% by weight of a desensitizing agent;
1 to 10% by weight of a pH-adjusting agents;
0.1 to 2.5% by weight of a chelating agents;
1 to 10% by weight of a surfactant; and
1 to 10% by weight of another additive,
based on the weight of the fountain solution concentrate.

5. A fountain solution comprising the fountain solution concentrate of claim 1 and water.

6. The fountain solution of claim 5, wherein a weight ratio of tert.-amyl alcohol to water is in a range of 1:200 to 20:100.

7. A method for preparing a fountain solution, the method comprising mixing the fountain solution concentrate of claim 1 with water.

8. A fountain solution comprising at least one selected from the group consisting of:
0.3 to 10% by weight of tert.-amyl alcohol;
70 to 99.5% by weight of water;
0.05 to 3% by weight of an auxiliary-wetting solvent;
0.05 to 3% by weight of a desensitizing agent;
0.05 to 3% by weight of a pH-adjusting agent;
0.01 to 0.5% by weight of a chelating agent;
0.05 to 3% by weight of a surfactant; and
0.05 to 3% by weight of another additive,
based on the weight of the fountain solution.

9-10. (canceled)

11. A method for offset printing, comprising applying the fountain solution of claim 5 to an image plate, thereby desensitizing a non-image area of the image plate.

12. A printed medium obtained by the method of claim 11.

13. The fountain solution concentrate of claim 1, which is suitable for offset printing.

14. The fountain solution concentrate of claim 2, further comprising water, wherein a weight ratio of tert.-amyl alcohol to water is in a range of 95:5 to 70:30.

15. The fountain solution concentrate of claim 4, comprising the tert.-amyl alcohol.

16. The fountain solution concentrate of claim 4, comprising the tert.-amyl alcohol and the water.

17. The fountain solution concentrate of claim 4, comprising the tert.-amyl alcohol and the auxiliary wetting solvent.

18. The fountain solution concentrate of claim 4, comprising the tert.-amyl alcohol and the desensitizing agent.

19. The fountain solution concentrate of claim 4, comprising the tert.-amyl alcohol and the pH-adjusting agent.

20. The fountain solution concentrate of claim 4, comprising the tert.-amyl alcohol and the chelating agent.

21. The fountain solution concentrate of claim 4, comprising the tert.-amyl alcohol and the surfactant.

22. The fountain solution concentrate of claim 4, comprising the tert.-amyl alcohol and the other additive.
